(19) United States
(12) Patent Application Publication
(10) Pub. No.: US 2014/0328246 A1
(43) Pub. Date: Nov. 6, 2014

(54) Mobile Relay Support in Relay-Enhanced Access Networks

(71) Applicants: Xiang Xu, Nanjing (CN); Simone Redana, Munich (DE); Hanns Juergen Schwarzbauer, Grobenzell (DE); Richard Waldhauser, Munich (DE)

(72) Inventors: Xiang Xu, Nanjing (CN); Simone Redana, Munich (DE); Hanns Juergen Schwarzbauer, Grobenzell (DE); Richard Waldhauser, Munich (DE)

(73) Assignee: Nokia Solutions and Networks Oy, Espoo (FI)

(21) Appl. No.: 14/348,644

(22) PCT Filed: Sep. 30, 2011
(86) PCT No.: PCT/EP2011/067126

§ 371 Date: Jun. 20, 2014

(51) Int. Cl. H04W 88/04; H04W 36/08

(52) U.S. Cl. CPC H04W 88/04; H04W 36/08
USPC 370/315

(57) ABSTRACT

Measures are provided for mobile relay support in relay-enhanced access networks. Such measures include setting up a first packet data connection for traffic in a relay-enhanced access network, which relates to first-type user terminals using the same access technology as a base station, from a mobile relay towards a packet data network via a first packet gateway functionality collocated with the base station currently serving the mobile relay, and setting up a second packet data connection for traffic in the relay-enhanced access network, which relates to second-type user terminals using another access technologies as the base station and the mobile relay, from the mobile relay towards the packet data network via a second packet gateway functionality external to the base station currently serving the mobile relay.

### FIELD

The present invention relates to mobile relay support in relay-enhanced access networks. More specifically, the present invention exemplarily relates to measures (including methods, apparatuses and computer program products) for mobile relay support in relay-enhanced access networks.

### BACKGROUND

The present specification basically relates to relaying using mobile relays in relay-enhanced access networks.

In the following, for the sake of intelligibility, LTE (Long-Term Evolution according to 3GPP terminology) or LTE-Advanced is taken as a non-limiting example for a radio access network being applicable in the context of the present invention and its embodiments. However, it is to be noted that any kind of radio access network may likewise be applicable, as long as it exhibits comparable features and characteristics as described hereinafter.

In the context of LTE and LTE-Advanced (i.e. in the context of release 9 and release 10 specifications), relaying has been proposed as one concept. In relaying, a user equipment (UE) or terminal is not directly connected with an access node such as a radio base station (e.g. denoted as eNodeB or eNB) of a radio access network (RAN), but via a relay node (RN). Relaying by way of RNs has been proposed as a concept for coverage extension in cellular systems. Apart from this main goal of coverage extension, introducing relay concepts can also help in providing high-bit-rate coverage in high shadowing environments, reducing the average radio-transmission power at the a user equipment (thereby leading to longer battery life), enhancing cell capacity and effective throughput, (e.g. increasing cell-edge capacity and balancing cell load), and enhancing overall performance and deployment cost of radio access networks.

Generally, in a relay-enhanced access network, such as e.g. a Long Term Evolution (LTE) RAN with radio-relaying extensions, UEs at disadvantaged positions such as a cell edge and/or high shadowing areas are connected to a so-called donor base station (DeNB) via a respective relay node (RN) which may be a mobile relay (MR). The link between DeNB and RN/MR may be referred to as backhaul link, relay link or Un link, the respective interface usually being referred to as Un interface, and the link between RN/MR and UE may be referred to as access link or Uu link, the respective interface usually being referred to as Uu interface.

FIG. 1 shows a schematic diagram of a typical deployment scenario of a relay-enhanced access network, such as e.g. a Long Term Evolution (LTE) RAN with radio-relayed extensions, in relation to a core network, such as e.g. an Evolved Packet Core (EPC) or another packet data network (PDN), for which exemplary embodiments of the present invention are applicable.

As shown in FIG. 1, it may be assumed that the radio access network RAN comprises one or more cells, each of which is served by one DeNB as an access node or base station. The mobile relay node MR is connected to a DeNB denoted as source via Un interface, and the DeNBs are connected to the backbone/core network via the S1 interface, respectively. For load sharing/balancing and handover purposes, the DeNBs and MRs communicate with each other through the X2 interface. The S1 and X2 interface is also conveyed over the Un interface. S1 and X2 interfaces may be handled by so called proxy functionality within the DeNB. As representative examples for backbone/core nodes of the backbone/core network, there are exemplarily depicted two entities which may e.g. be UE and/or MR MME (MME: mobility management entity) and/or UE S-/P-GW nodes. Any DeNB is connected with one such gateway node, respectively. As indicated by a dashed arrow, the MR may move and, thus, perform a handover (along with all its associated UEs) from the source DeNB to a target DeNB.

Mobile relays are generally most efficient in dynamic network and deployment scenarios. For example, in high speed public transportation, mobile relays could be implemented by relays being mounted in high speed vehicles (e.g. trains) and being wirelessly connected to the RAN infrastructure, particularly to a DeNB via a wireless backhaul link. Thereby, problems in such in dynamic network and deployment scenarios could be solved, like avoiding a reduction in handover success rate due to a high frequency of required handovers and/or a high number of simultaneous handover requests from all users residing in a high speed vehicle and/or less accurate UE-based measurements due to the high speed, avoiding a degraded throughput due to high Doppler effects on high speed vehicles, and providing a good quality of service for users on board of high speed vehicles.

In such scenarios of high speed public transportation or the like, it would be beneficial when the mobile relay provides for multimode relaying capabilities. Namely, in order to provide wireless connectivity services to as many users as possible, a mobile relay being operable with various access technologies (via various air interfaces) on the access link would be specifically effective. For example, such multimode mobile relay may be operable, i.e. provide connectivity services for user terminals having GSM/UTRAN/WiFi air interfaces and the like.

FIG. 2 shows a schematic diagram of a conventional relay architecture, as currently specified for 3GPP-based relay-enhanced access networks, which could also be referred to as a nomadic relay architecture.

As shown in FIG. 2, the currently specified relay architecture assumes that the DeNB embeds and provides the additional S-GW/P-GW functionalities needed for the relay operation. For example, this includes creating a session for the relay node and managing EPS bearers for the relay node, as well as terminating the S11 interface towards the MME serving the relay node. The P-GW functionalities in the DeNB may allocate an IP address for the relay node for O&M and the like. The conventional relay architecture according to FIG. 2 only supports a nomadic relay node, without considering the support for a mobile relay.

The DeNB appears to the relay node as an MME (for S1-MME, i.e. the control plane on the S1 interface) and an S-GW (for S1-U, i.e. the user plane on the S1 interface), and the DeNB appears to UE's MME/S-GW as an eNB (i.e. base station or access node). Accordingly, as indicated in FIG. 2, there is a PDN connection between the relay node and the core/backbone/PDN side of the access network via the DeNB, which handles both user-related traffic to/from the UE's S-GW/P-GW and relay-related traffic to/from the relay node's O&M server.

In such relay architecture, the DeNB is aware of the individual UE EPS bearers of all of the relayed UEs. That is, the DeNB is aware of the relayed UEs as well as of the relay nodes with which the relayed UEs are connected. Specifically, the DeNB acts like a proxy for S1/X2 connections, and the relay node appears as a cell within the DeNB.

However, the current relay architecture is not capable of supporting the mobility of a mobile relay (MR) in an appropriate manner in view of existing requirements in this regard.

Firstly, when the MR performs a handover to a target DeNB, the current relay architecture breaks the connection used for MR's O&M traffic, as well as the connection for the air interface traffic when the MR is multimode supporting GSM/UTRAN/WiFi. The MR's downlink traffic is routed to the P-GW collocated with the DeNB, which assigned the IP address for the MR. In this case, the MR's downlink traffic is sent to the P-GW collocated with the source DeNB. In this regard, it is not feasible to enable that the MR's O&M server and the supported system's RAN control entity (e.g. GSM BSC, UTRAN RNC/HNB-GW, WiFi Core, etc.) change the downlink path. Accordingly, even if relocating the P-GW from the source DeNB to the target DeNB could not prevent the respective connections from being interrupted during the MR handover.

Secondly, the current handover mechanisms treat the MR as a normal UE. During the S1 handover or the X2 handover, the source DeNB only transfers context information related to the MR to the target DeNB. The UE's context information, i.e. S1-MME/S1-U information, are not transmitted to the target DeNB. Without the S1-MME/S1-U context information for the UEs connecting to the MR, the target DeNB cannot work correctly, i.e. cannot proxy the S1-MME and S1-U between the MR and the UE's MME/S-GW. Details in this regard are explained below with respect to FIGS. 3 and 4.

Thirdly, assuming the aforementioned exemplary scenario, when the UE stays in the vehicle in which the MR is implemented, the UE does not experience any mobility. Hence, the UE's MME/S-GW remains unchanged even if the vehicle is very far away from the UE's MME/S-GW. This requires the DeNB to connect to all MMES along the vehicle's route, even if it is very far away. This is very inefficient, especially when considering that 3GPP already supports the relocation of MME/S-GW for better performance.

In view thereof, there arise various problematic issues when applying conventionally known handover mechanisms (which are actually specified for UE mobility/handover) in terms of mobile relay mobility/handover. While details of such conventionally known handover mechanisms (which are actually specified for UE mobility/handover) in terms of mobile are omitted for the sake of brevity, the problematic issues arising in this regard are illustrated in FIGS. 3 and 4.

FIG. 3 shows a schematic diagram of a conventional X2 handover procedure for a mobile relay, which illustrates problematic issues in terms of a mobile relay handover.

FIG. 4 shows a schematic diagram of a conventional S1 handover procedure for a mobile relay, which illustrates problematic issues in terms of a mobile relay handover.

For details regarding the problematic issues arising in both cases, reference is made to the illustrations, from which the relevant problems, drawbacks and deficiencies are deemed to be evident for a skilled person.

As shown in FIGS. 3 and 4, when applying conventional X2- or S1-based handover mechanisms, various issues at various involved entities are to be resolved for providing support of the mobility of a mobile relay in an appropriate manner in view of existing requirements in this regard.

In view thereof, there is a need to provide for improvements in the context of, thus facilitating, mobile relay support in relay-enhanced access networks.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising setting up a first packet data connection for traffic in a relay-enhanced access network, which relates to first-type user terminals using the same access technology as a base station from a mobile relay towards a packet data network via a first packet gateway functionality collocated with the base station currently serving the mobile relay, and setting up a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

Advantageous further developments are as set out in respective dependent claims thereof.

According to an exemplary aspect of the present invention, there is provided a method comprising servicing a first packet data connection for traffic in a relay-enhanced access network, which relates to the first-type user terminals using the same access technology as a base station, from a mobile relay towards a packet data network via a first packet gateway functionality collocated with the base station currently serving the mobile relay, and servicing a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

Advantageous further developments are as set out in respective dependent claims thereof.

According to an exemplary aspect of the present invention, there is provided an apparatus comprising an interface configured to communicate with at least another apparatus, a processor configured to cause the apparatus to perform: setting up a first packet data connection for traffic in a relay-enhanced access network, which relates to the first-type user terminals using the same access technology as a base station, from a mobile relay towards a packet data network via a first packet gateway functionality collocated with a base station currently serving the mobile relay, and setting up a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

Advantageous further developments are as set out in respective dependent claims thereof.

According to an exemplary aspect of the present invention, there is provided an apparatus comprising an interface configured to communicate with at least another apparatus, a processor configured to cause the apparatus to perform: servicing a first packet data connection for traffic in a relay-enhanced access network, which relates to the first-type user terminals using the same access technology as a base station, from a mobile relay towards a packet data network via a first packet gateway functionality collocated with a base station currently serving the mobile relay, and servicing a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

Advantageous further developments are as set out in respective dependent claims thereof.

According to an exemplary aspect of the present invention, there is provided a computer program product including comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned methodrelated exemplary aspects of the present invention.

Such computer program product may be embodied as a (tangible) computer-readable storage medium or the like.

For example, according to further developments or modifications of any one of the aforementioned exemplary aspects of the present invention, additional context information for one or more contexts of user terminals connecting to the mobile relay may be conveyed from a source base station to a mobile relay, and/or a group context update procedure for the one or more contexts of user terminals connecting to the mobile relay may be performed in at least one of a mobile relay, the target base station, a mobility management entity of the user terminals, any mobility management entity in case the mobility management entity of the user terminal is unavailable, and a serving gateway entity of the user terminals.

By way of exemplary embodiments of the present invention, there is provided mobile relay support in relay-enhanced access networks. More specifically, by way of exemplary embodiments of the present invention, there are provided measures and mechanisms for mobile relay support in relay-enhanced access networks.

Thus, improvement is achieved by methods, apparatuses and computer program products enabling mobile relay support in relay-enhanced access networks.

### BRIEF DESCRIPTION OF THE DRAWINGS

In the following, the present invention will be described in greater detail by way of non-limiting examples with reference to the accompanying drawings, in which

FIG. 1 shows a schematic diagram of a typical deployment scenario of a relay-enhanced access network in relation to a core network, for which exemplary embodiments of the present invention are applicable,

FIG. 2 shows a schematic diagram of a conventional relay architecture,

FIG. 3 shows a schematic diagram of a conventional X2 handover procedure for a mobile relay, which illustrates problematic issues in terms of a mobile relay handover,

FIG. 4 shows a schematic diagram of a conventional S1 handover procedure for a mobile relay, which illustrates problematic issues in terms of a mobile relay handover,

FIG. 5 shows a schematic diagram of procedures of mobile relay support in relay-enhanced access networks according to exemplary embodiments of the present invention,

FIG. 6 shows a schematic diagram of a relay architecture based on the procedure of setting up packet data connections according to exemplary embodiments of the present invention,

FIG. 7 shows a schematic diagram of a first example of a relay architecture based on the procedure of setting up packet data connections, which supports multiple access technologies in the mobile relay, according to exemplary embodiments of the present invention,

FIG. 8 shows a schematic diagram of a second example of a relay architecture based on the procedure of setting up packet data connections, which supports multiple access technologies in the mobile relay, according to exemplary embodiments of the present invention,

FIG. 9 shows a schematic diagram of various examples of the procedure of conveying additional context information according to exemplary embodiments of the present invention,

FIG. 10 shows a schematic diagram of a first example of the procedure of group-based updating of contexts according to exemplary embodiments of the present invention,

FIG. 11 shows a schematic diagram of a second example of the procedure of group-based updating of contexts according to exemplary embodiments of the present invention, and

FIG. 12 shows a schematic diagram of apparatuses according to exemplary embodiments of the present invention.

### DETAILED DESCRIPTION OF EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certaro exemplary network configurations and deployments. Namely, the present invention and its embodiments are mainly described in relation to 3GPP specifications being used as non-limiting examples for certain exemplary network configurations and deployments. In particular, an LTE (E-UTRAN) radio access network and corresponding standards (LTE releases 8, 9 and LTE-Advanced release 10 and beyond) are used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any relay-enhanced or heterogeneous (cellular) system with a need for enabling relay node handovers. The present invention and its embodiments may be applicable for/in any kind of modern and future communication network including any conceivable mobile/wireless communication networks according to 3GPP or IEEE specifications.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided measures and mechanisms for mobile relay support in relay-enhanced access networks.

FIG. 5 shows a schematic diagram of procedures of mobile relay support in relay-enhanced access networks according to exemplary embodiments of the present invention.

As shown in FIG. 5, exemplary embodiments of the present invention comprise one or more of three basic (logical) procedures for supporting the mobility of a mobile relay.

A first (logical) procedure according to exemplary embodiments of the present invention is a procedure of setting up packet data connections. Such procedure basically comprises setting up a packet data connection for traffic in a relay-enhanced access network, which relates to the first-type user terminals using the same access technology as a base station, from a mobile relay towards a packet data network via a first packet gateway functionality collocated with the base station currently serving the mobile relay, which is separate from a packet data connection for traffic in the relay-enhanced access network, which relates to at least one of second-type user terminals using another access technology as the base station and the mobile replay (such as the mobile relay's operation and maintenance traffic), from the mobile relay towards the packet data network via a second packet gateway functionality external to the base station currently serving the mobile relay.

According to an exemplary embodiment of the present invention, as illustrated in FIG. 5, such procedure may comprise that the MR, upon power up (for relay operation) and attachment to a currently serving DeNB (i.e. the source DeNB), sets up two PDN connections between the MR and the PDN under the control of, e.g. the MR's MME. The first PDN connection uses the S-GW/P-GW collocated in the source DeNB, and the second PDN connection (or the set of second PDN connections) uses the P-GW that is external to source DeNB. The DeNB terminates an interface (e.g. the S5 interface) for interfacing with the external P-GW in order to set up a GTP tunnel with the P-GW that is external to the DeNB. Accordingly, during a handover of the mobile relay, the first PDN connection is relocated as both the S-GW and the P-GW collocated with the source DeNB are relocated to the target DeNB, while the second PDN connection (or the set of second PDN connections) remains unchanged as the P-GW external to the source DeNB remains being used and only the S-GW collocated with the source DeNB is relocated.

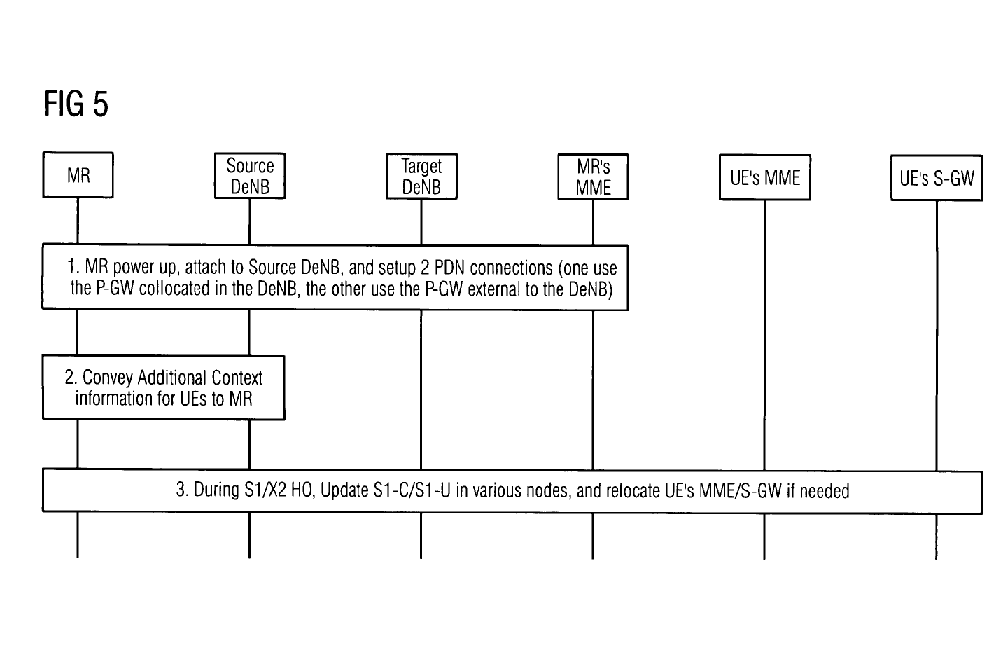

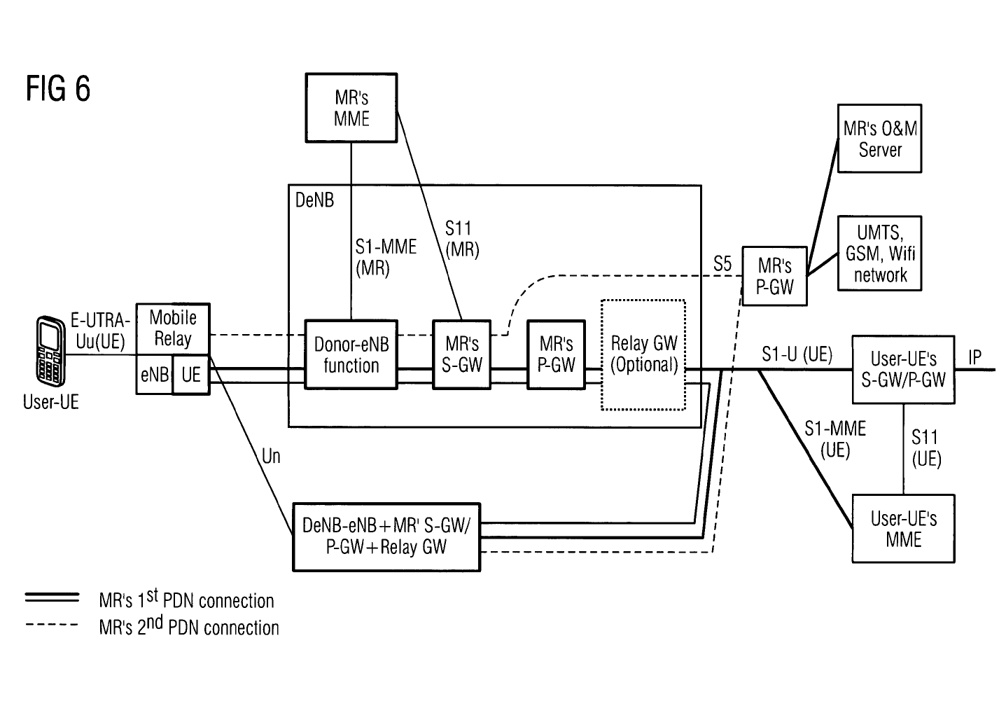

Such procedure according to an exemplary embodiment of the present invention is effective in providing a separation (in the handling/treatment of) between the traffic related to the first-type user terminals using the same access technology as the DeNB, e.g. LTE, and all other traffic, i.e. the traffic related to the second-type user terminals using other access technologies, e.g. GSM, UTRAN, WiFi, etc., and the traffic related to the mobile relay itself, e.g. the MR's O&M traffic Further details thereof are explained in connection with FIGS. 6 to 8 below.

A second (logical) procedure according to exemplary embodiments of the present invention is a procedure of conveying additional context information. Such procedure basically comprises conveying additional context information for one or more contexts of first-type and second-type user terminals connecting to the mobile relay from a source base station to a mobile relay.

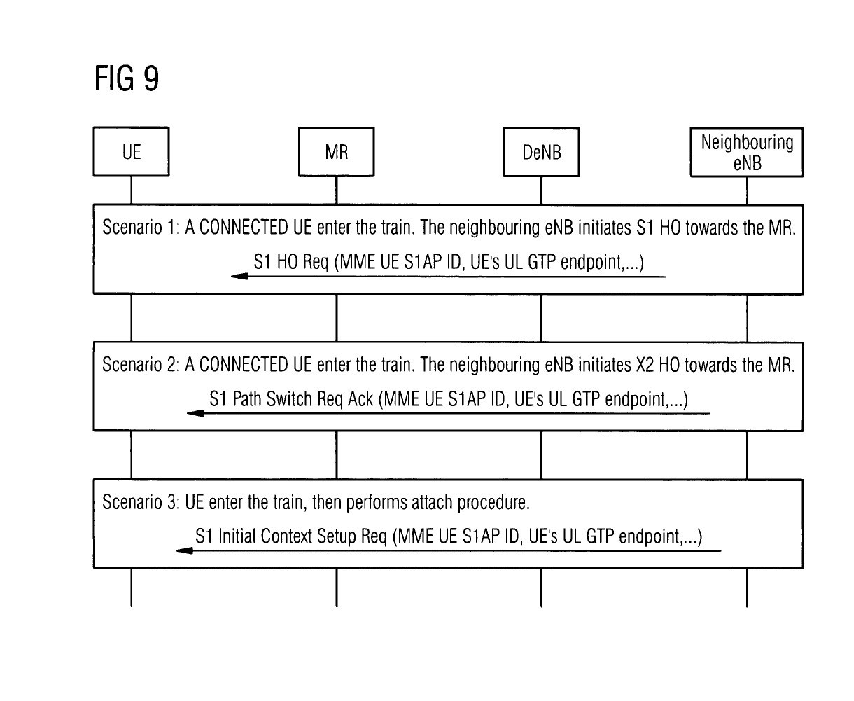

Such procedure according to an exemplary embodiment of the present invention is effective in providing (full) transport/tunnel information enabling transmission and/or tunneling of control plane and user plane traffic for the user terminal between the mobile relay and a mobility management entity and/or a serving gateway functionality of the user terminal, namely in providing support for a (group) context update during a MR handover in advance of the MR handover. Further details thereof are explained in connection with FIG. 9 below.

A third (logical) procedure according to exemplary embodiments of the present invention is a procedure of group-based updating of UE contexts for first-type and second-type user terminals. Such procedure basically comprises performing a context update procedure for one or more contexts of user terminals connecting to a mobile relay between a mobile relay and a target base station of the mobile relay, and between the target base station and the mobility management entity and/or the serving gateway of the user terminal, after a handover thereof.

According to an exemplary embodiment of the present invention, as illustrated in FIG. 5, such procedure may comprise that, during a S1/X2 MR handover, the MR initiates an UE context update of all connected UEs in various nodes (i.e. triggers the UE context update and at the various nodes) and, when appropriate, that the mobility management entity and/or a serving gateway functionality of the/each user terminal is relocated.

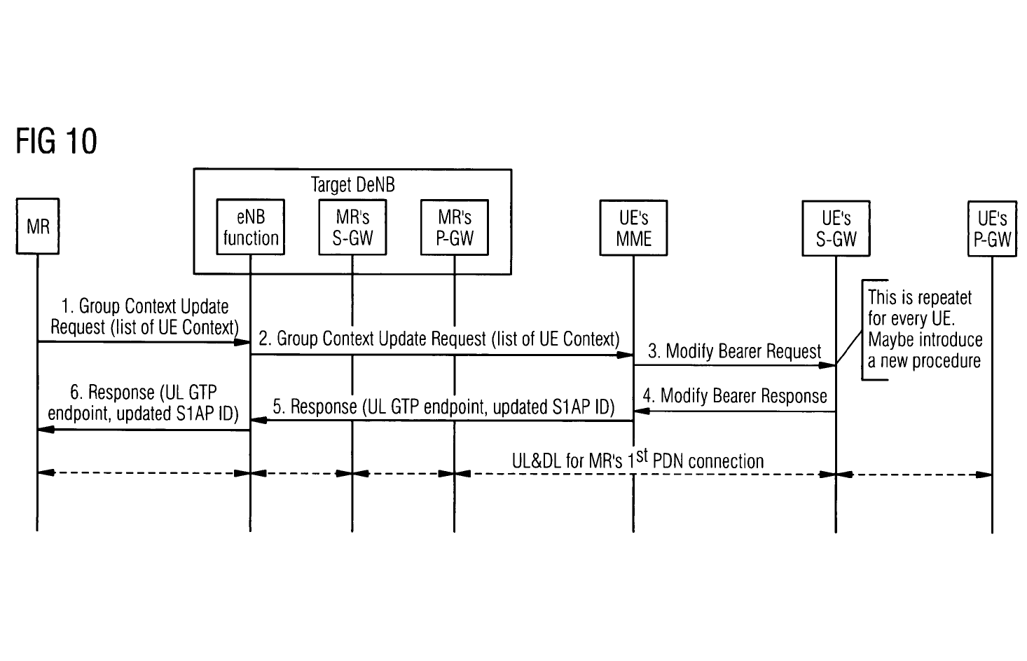

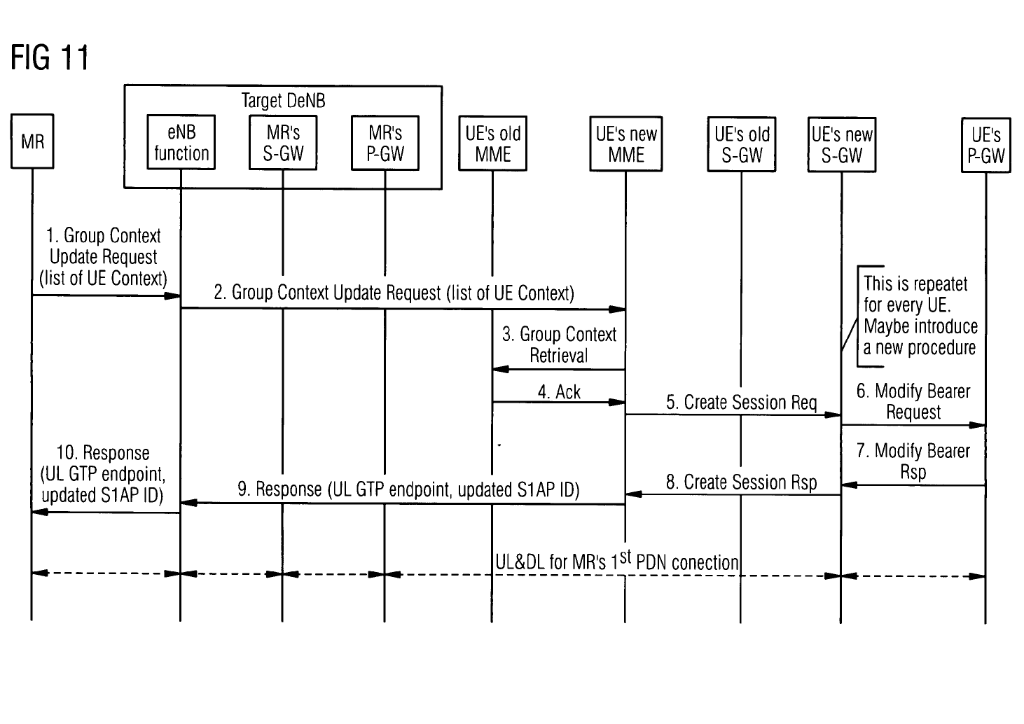

Such procedure according to an exemplary embodiment of the present invention is effective in facilitating block procedures for group-based context updating in terms of UEs' context (i.e. the context for the control plane and user plane of all UEs) relating to the mobile relay. Thereby, all contexts for the user terminals may be updated/moved by a single procedure. Further details thereof are explained in connection with FIGS. 10 and 11 below.

With respect to FIG. 5, it is to be noted that the thus illustrated three basic (logical) procedures for supporting the mobility of a mobile relay represent distinct procedures which are inherently separate and independent of each other. Yet, one or more of these three basic (logical) procedures may be combined for supporting the mobility of a mobile relay according to exemplary embodiments of the present invention.

For example, the second and third procedures may be operable on/for the PDN connection for the traffic related to the first-type user terminals using the same access technology as the base station using the P-GW collocated with the currently serving DeNB, i.e. the first PDN connection according to the first procedure. That is, the establishment of the second PDN connection (or the set of second PDN connections) according to the first procedure is not required for the second and third procedures.

For example, the third procedure may be operable on the basis of the second procedure, i.e. the (group-based) context update procedure may be performed on the basis of the additional context information being conveying according to the second procedure.

With respect to FIG. 5, it is to be noted that any one or more of the thus illustrated three basic (logical) procedures for supporting the mobility of a mobile relay may be applied to or in combination with a technique of proxy relocation during a (mobile) relay node handover. Such technique of proxy relocation may comprise a relocation of a proxy functionality for a (mobile) relay node of a relay-enhanced access network from a source base station to a target base station during a handover of the (mobile) relay node. The relocation of the proxy functionality may exemplarily comprise a relocation of co-located serving gateway and packet data network gateway functionalities for the (mobile) relay node from the source base station to the target base station.

For example, any one or more of the thus illustrated three basic (logical) procedures may be applied to or in combination with a technique to relocate the MR's P-GW from the source DeNB to the target DeNB.

For example, any one or more of the thus illustrated three basic (logical) procedures may be applied to or in combination with a technique using a handover request message for delivering the MR's UEs context to the target DeNB.

With respect to FIG. 5, exemplary embodiments of the present invention may provide for one or more of improvements/enhancements in terms of capability exchange, handover preparation for a mobile relay, relocation of a mobile relay's S-GW/P-GW, group context update in various nodes (e.g. MR, DeNB, UE's MME/S-GW), and relocation of UE's MME/S-GW.

According to exemplary embodiments of the present invention, i.e. by virtue of one or more of the basic procedures as illustrated in FIG. 5 and/or details thereof as explained in connection with FIGS. 6 to 11, one or more of the following effects may be achieved.

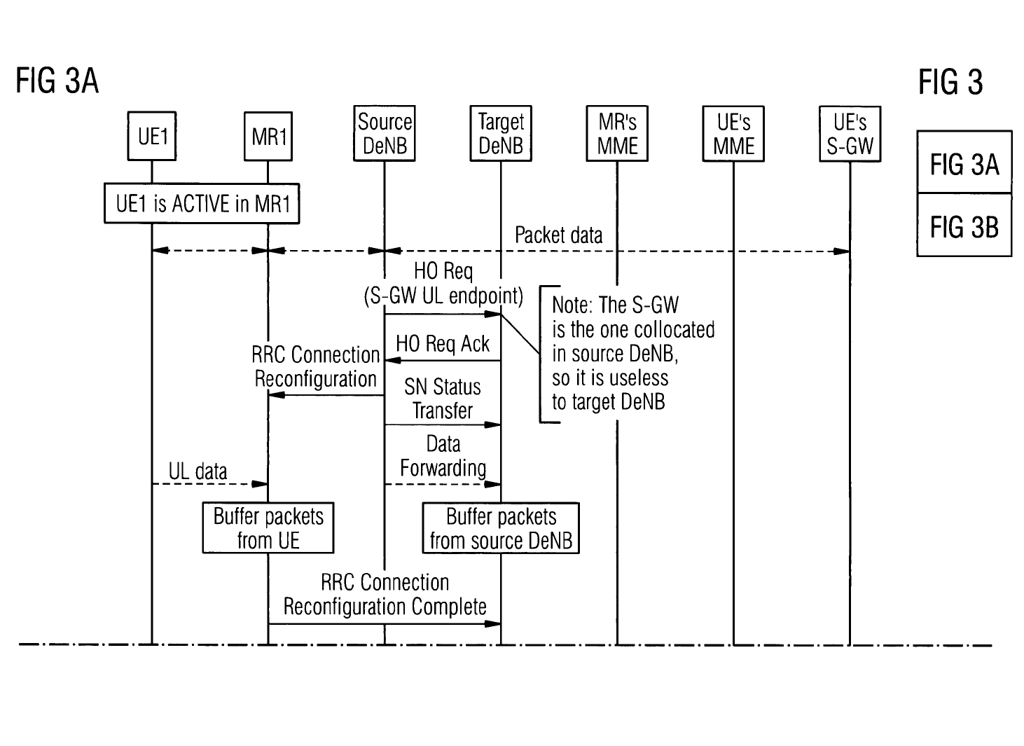

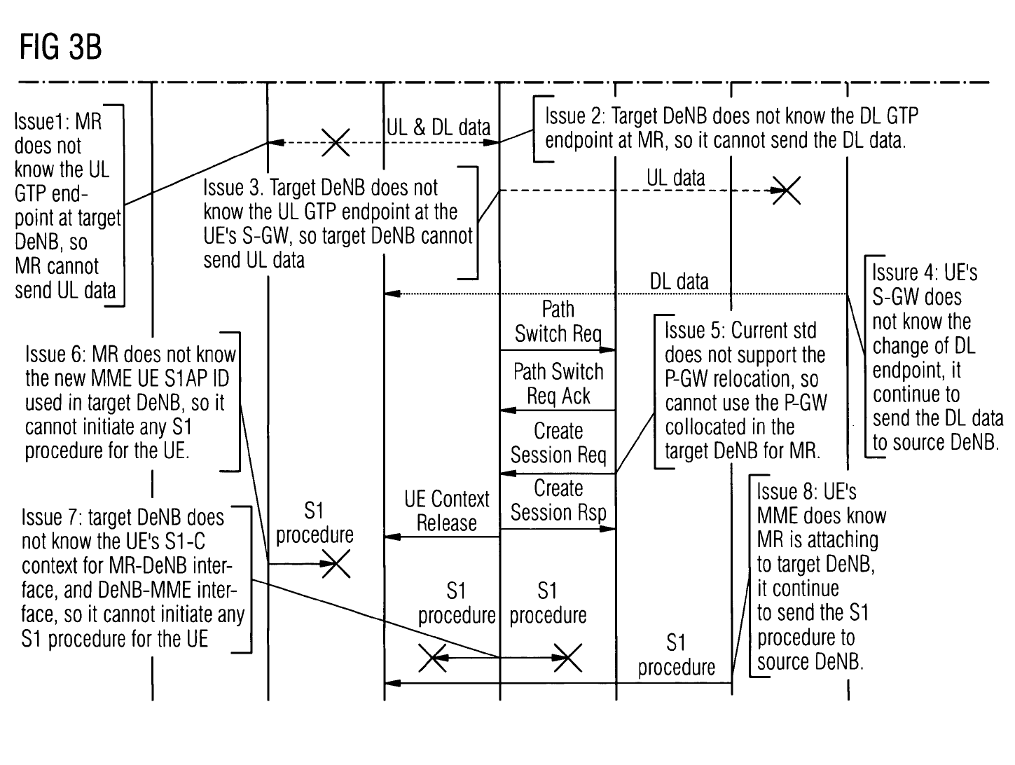

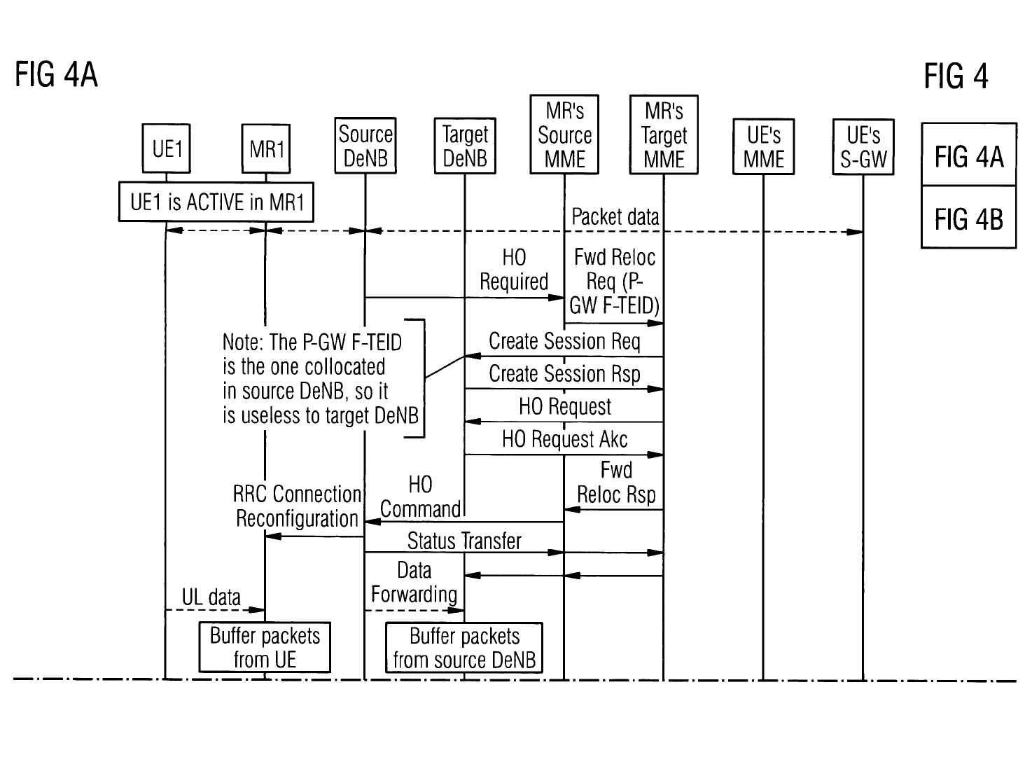

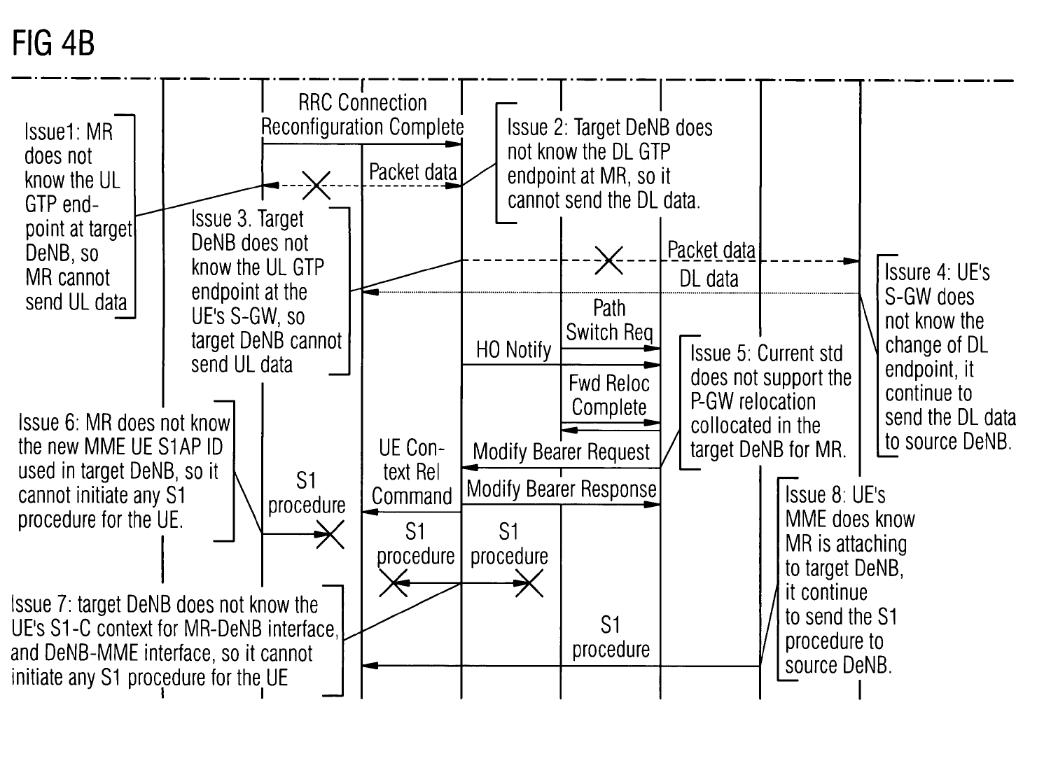

The problematic issues in the context of conventional handover mechanisms, as illustrated in FIGS. 3 and 4, may be resolved. That is, respective effects correspond to illustrated Issues 1-8 in any one of FIGS. 3 and 4 may be provided.

A clean and smooth group-wise movement of UEs served by a MR handing over to a new DeNB may be accomplished.

The reusability of the currently specified relay architecture in 3GPP Release 10 may be maximized or optimized. This is especially beneficial in terms of product implementation.

The connectivity for MR's O&M may be maintained during the MR's mobility or handover. Also, the mobility may be easily supported, if the MR exhibits a multimode capability that supports various technologies, such as e.g. UTRAN/GSM/WiFi.

The handover procedure may be accelerated, e.g. by using a single procedure for a group update of the UE context in various nodes.

The impact to existing networks, deployments and specifications may be minimized, i.e. no change to the MR's neighboring eNB, P-GW, etc. is required.

The impact in further standardization is minimized in that only one new group-based procedure is introduced to update the UE context in MR, DeNB and UE's MME, etc.

The relocation of UE's MME/S-GW is supported, which does not require the DeNB to connect to all MME's along the vehicle's route in the aforementioned example, and allows using the MME/S-GW most close to the UE's current position to achieve better performance.

In case of network sharing, the RAN operator is free to add/remove a mobile relay or support thereof without any impact to the CN operator.

As mentioned above, according to exemplary embodiments of the present invention, a MR may set up, and a DeNB may service, a PDN connection used for the traffic related to first-type user terminals using the same access technology as the DeNB, to be separate from a PDN connection used for all other traffic, e.g. traffic related to second-type user terminals using other access technologies and the mobile relay (such as the mobile relay's operation and maintenance traffic). In particular, a MR may set up, and a DeNB may service, two PDN connections using currently specified procedures (e.g. 3GPP Release-10-based procedures). The first PDN connection may use the P-GW collocated in the DeNB, while the second PDN connection (or the set of second PDN connections) may use the P-GW external to the DeNB. The DeNB supports an interface (e.g. the S5 interface) for interacting with the external P-GW, which enables to service the second PDN connection (or the set of second PDN connections).

By virtue of the separate PDN connections as outlined above, a continuous and uninterrupted connection during a MR handover is enabled, as the P-GW of the second PDN connection (or the set of second PDN connections) is not relocated.

Such procedure may result in the relay architecture according to exemplary embodiments of the present invention, as illustrated in any one of FIGS. 6 to 8. As shown in FIGS. 6 to 8, different PDN connections are established by the MR for different types of traffic.

FIG. 6 shows a schematic diagram of a relay architecture based on the procedure of setting up packet data connections according to exemplary embodiments of the present invention, i.e. the first basic procedure as illustrated in FIG. 5.

The first PDN connection uses the S-GW/P-GW collocated in the DeNB currently serving the MR (e.g. the source DeNB), which is relocated (to the target DeNB) during a S1/X2 handover of the MR. The first PDN connection is used for the S1-MME and S1-U traffic for all User-UEs connecting to the MR via the LTE or LTE-A air interface, which are assumed as first-type user terminals here. By using the S1 group context update procedure according to exemplary embodiments of the present invention, which is denoted as the third (basic) procedure herein, the S1-MME and S1-U traffic for all UEs connecting to the MR are maintained during the MR's mobility or handover.

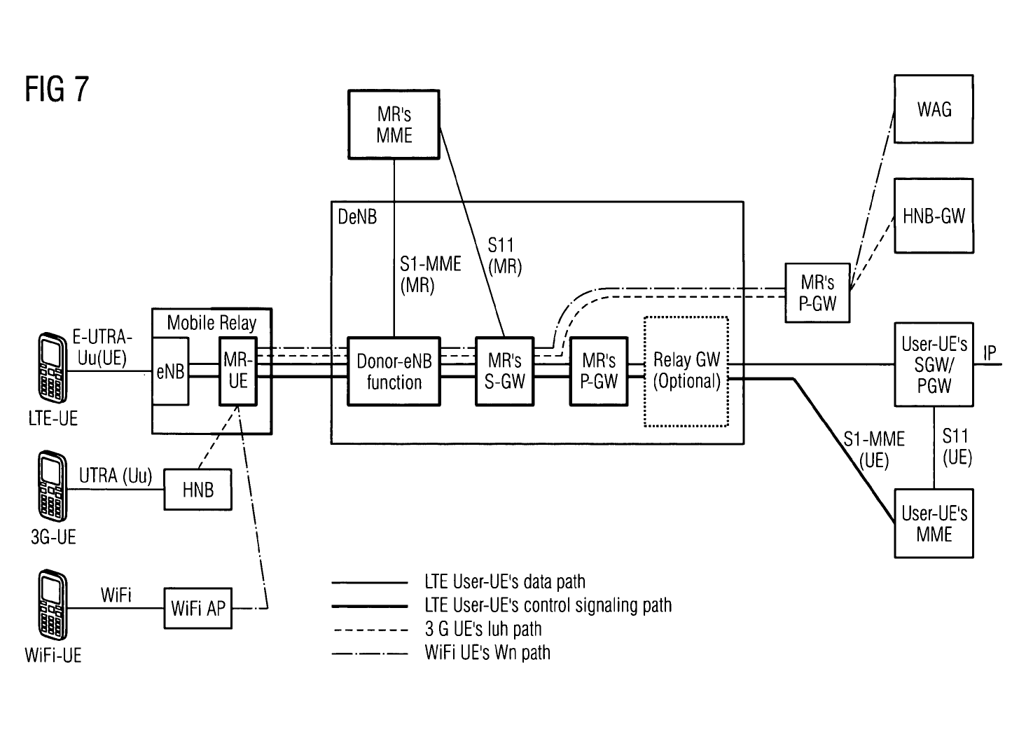

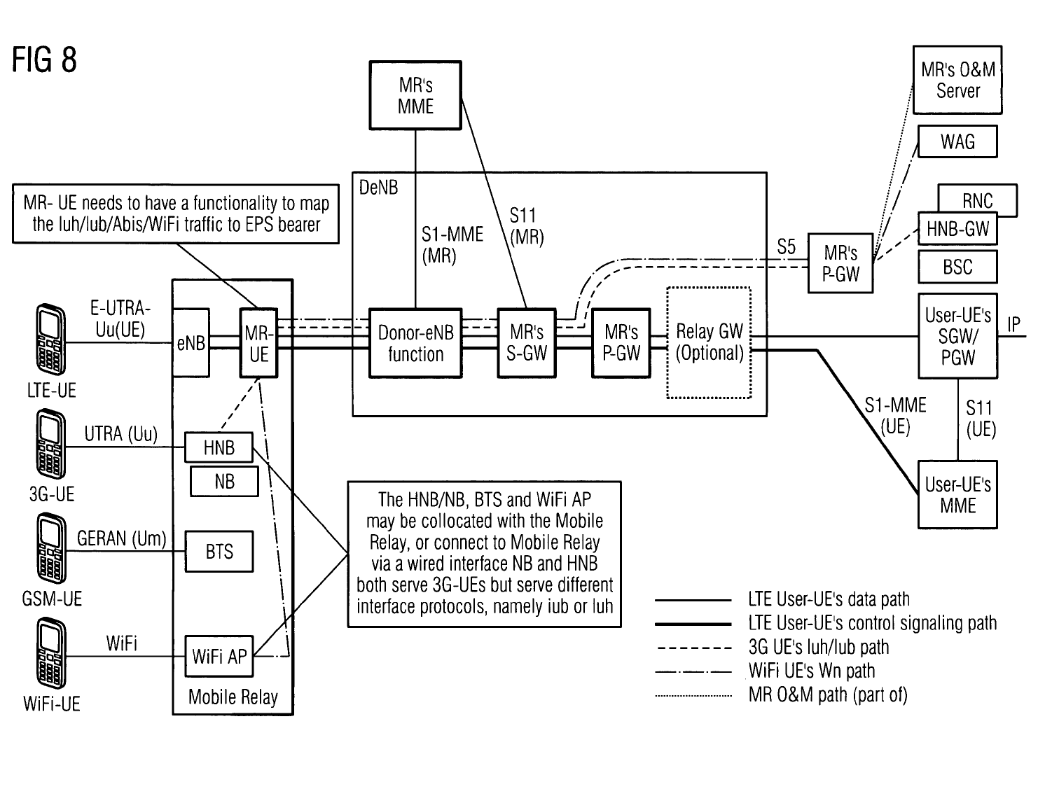

The second PDN connection, and any further PDN connection, that is related to all traffic other than that served by the first PDN connection (see FIGS. 7 and 8 for details in this regard) uses the S-GW collocated in the source DeNB and a P-GW that is external to the DeNB currently serving the MR (e.g. the source DeNB), which therefore remains unchanged during a S1/X2 handover of the MR. This second (and may be any further) PDN connection is used for the MR's O&M, and GSM/3G/WiFi traffic (i.e. all traffic other than LTE/LTE-A traffic or, stated in other words, traffic from second-type user terminals). By using the second PDN connection (and may be any further), the connection for the MR's O&M traffic (as well as the GSM/3G/WiFi traffic) is maintained during the MR's mobility or handover.

FIG. 7 shows a schematic diagram of a first example of a relay architecture based on the procedure of setting up packet data connections, which supports multiple access technologies in the mobile relay, according to exemplary embodiments of the present invention, i.e. the first basic procedure as illustrated in FIG. 5.

The relay architecture of FIG. 7 represents a variation of the relay architecture of FIG. 6, in order to support user terminals using 3G or WiFi access technology in addition to user terminals using LTE/LTE-A access technology.

In the example of FIG. 7, it is assumed that a 3G UE connects to the MR via a wireless UE-HNB link and a (usually wired) HNB-MR link, and a WiFi UE connects to the MR via a wireless UE-WiFi AP link and a (usually wired) WiFi AP-MR link. The HNB may thus communicate via Iuh interface with the HNB-GW, and the WiFi AP may thus communicate via Wn interface with the WAG. That is, in the example of FIG. 7, it is assumed that the HNB and/or the WiFi AP are not collocated with the MR.

The traffic related to the LTE/LTE-A UE, i.e. both control plane and user plane traffic of first-type user terminals, is transmitted over a PDN connection (constituting a first PDN connection) using the P-GW that is collocated to the DeNB.

The other traffic is transmitted over one or more additional PDN connections (constituting a set of second PDN connections). Namely, the traffic related to the 3G-UE and the traffic related to the WiFi-UE, i.e. the traffic of the second-type user terminals, are each transmitted over a PDN connection (or a set of PDN connections) using the P-GW that is external to the DeNB, respectively. For 3G uplink traffic, the P-GW transmits the 3G (Iuh) traffic to the HNB-GW. For WiFi traffic, the P-GW transmits the WiFi (Wn) traffic to the WAG. The P-GW also receives the 3G (Iuh) traffic from the HNB-GW and the WiFi (Wn) traffic from the WAG, and transmits it to the HNB/WiFi AP via the second PDN connection (or a set of the second PDN connections).

FIG. 8 shows a schematic diagram of a second example of a relay architecture based on the procedure of setting up packet data connections, which supports multiple access technologies in the mobile relay, according to exemplary embodiments of the present invention, i.e. the first basic procedure as illustrated in FIG. 5.

The relay architecture of FIG. 8 represents a variation of the relay architecture of FIG. 6, in order to support user terminals using 3G or GSM or WiFi access technology in addition to user terminals using LTE/LTE-A access technology.

In the example of FIG. 8, it is assumed that 3G HNB/NB, GSM BTS and WiFi AP are collocated with the MR. That is, it is assumed that a 3G UE connects to the MR, i.e. HNB/NB therein, via a wireless link, a GSM UE connects to the MR, i.e. BTS therein, via a wireless link, and a WiFi UE connects to the MR, i.e. the WIFi AP therein, via a wireless link, respectively. The MR-collocated HNB/NB may thus communicate via Iuh/Iub interface with the HNB-GW/RNC, the WiFi AP may thus communicate via Wn interface with the WAG, and (although not depicted for the sake of clarity) the BTS may thus communicate via Abis interface with the BSC.

The traffic related to the LTE/LTE-A UE, i.e. both control plane and user plane traffic of first-type user terminals, is transmitted over a PDN connection (constituting a first PDN connection) using the P-GW that is collocated to the DeNB.

The other traffic is transmitted over one PDN connection or various PDN connections (constituting a set of PDN connections). Namely, the traffic related to the 3G-UE, the traffic related to GSM-UE and the traffic related to the WiFi-UE, i.e. the traffic of second-type user terminals, as well as the traffic related to the MR's O&M are transmitted over one PDN connection, or each transmitted over a PDN connection, using the P-GW that is external to the DeNB, respectively. For 3G uplink traffic, the P-GW transmits the 3G (Iuh/Iub) traffic to the HNB-GW/RNC. For WiFi traffic, the P-GW transmits the WiFi (Wn) traffic to the WAG. For GSM traffic, the P-GW transmits the GSM (Abis) traffic to the BSC. For MR's O&M traffic, the P-GW transmits the O&M traffic to the MR's O&M server. The P-GW also receives the 3G (Iuh/Iub) traffic from the HNB-GW/RNC, the WiFi (Wn) traffic from the WAG, the GSM (Abis) traffic from the BSC, and the O&M traffic from the MR's O&M server.

In view of the alternative architectural examples of FIGS. 7 and 8 above, it is noted that (although depicted simultaneously for the sake of completeness) the presence of HNB communicating via Iuh interface with the HNB-GW or NB communicating via Iub interface with the RNC is represent alternatives. In this regard, it is noted that, in case of 3G traffic, the use of an HNB connected to an HNB-GW is preferable, as the Iuh interface is typically not suffering from increased delay as compared with the Iub interface.

Further, it is noted that all the depicted different access technologies and/or relay architectures according to FIGS. 6 to 8 might also be combined into in any conceivable manner. Referring to FIGS. 6 to 8 above, it is further noted that additional PDN connections may be established following the procedure as described above for the second PDN connection. This may for example be applicable when the relay-related traffic needs to be handled by different P-GWs, e.g. WiFi traffic may for any reasons need to be handled by another P-GW than 3G or GSM traffic.

FIG. 9 shows a schematic diagram of various examples of the procedure of conveying additional context information according to exemplary embodiments of the present invention, i.e. the second basic procedure as illustrated in FIG. 5.

As mentioned above, according to exemplary embodiments of the present invention, the DeNB currently serving the MR (i.e. the source DeNB prior to a MR handover) may convey additional context information for all connected User-UEs to the MR, and the MR may save it for its upcoming S1/X2 handovers.

According to exemplary embodiments of the present invention, a DeNB may convey additional context information to the MR. The additional context information may generally include any information enabling transmission and/or tunneling of control plane and user plane traffic for the relevant UE or UEs between the MR and an UE's MME/S-GW. Specifically, the additional context information may include (in addition to GUMMEI that it is already supported by current specifications), but is not limited to, an identifier of an UE's S1AP (such as e.g. MME UE S1AP ID assigned by the UE's MME) and/or an UE's uplink tunneling protocol endpoint (such as e.g. UE's GTP-U UL endpoint assigned by the UE's S-GW), and/or the like.

In view thereof, exemplary embodiments of the present invention comprise one or more of the following scenarios of conveying the additional context information.

As shown as Scenario 1 in FIG. 9, it may exemplarily be presumed that a connected UE enters a train in which the MR is installed. In such scenario, the neighboring eNB previously serving the UE may initiate a S1 handover towards the MR. During the S1 handover, the DeNB may convey additional context information (such as e.g. one or more of the aforementioned parameters) for the connected UE to the MR via a S1 HANDOVER REQUEST message.

As shown as Scenario 2 in FIG. 9, it may exemplarily be presumed that a connected UE enters a train in which the MR is installed. In such scenario, the neighboring eNB previously serving the UE may initiate a X2 handover towards the MR. During the X2 handover, the DeNB may convey additional context information (such as e.g. one or more of the aforementioned parameters) for the connected UE to the MR via a PATH SWITCH REQUEST ACKNOWLEDGE messages.

As shown as Scenario 3 in FIG. 9, it may exemplarily be presumed that a UE performs an attach procedure. In such scenario, the DeNB may convey addition context information (such as e.g. one or more of the aforementioned parameters) for the UE to the MR via an INITIAL CONTEXT SETUP REQUEST message.

In each of the aforementioned scenarios, the MR may save the received additional context information for further use, e.g. for a group context update described herein.

FIGS. 10 and 11 show schematic diagrams of examples of the procedure of group-based updating of contexts according to exemplary embodiments of the present invention, i.e. the third basic procedure as illustrated in FIG. 5.

As mentioned above, according to exemplary embodiments of the present invention, during a S1/X2 handover of a MR, the MR may initiate a group context update procedure for (all) UEs connecting to the MR. This may also trigger the DeNB currently serving the MR (i.e. the target DeNB) to initiate the group context update procedure towards the UE's MME/S-GW. That is to say, the DeNB may proxy the group context update procedure between the MR and the further network elements such as UE's MME/S-GW and the like. The group context update procedure may update the context for the respective UE/UEs in any one of the MR, the target DeNB, the UE's MME and the UE's S-GW. When there is a need to relocate the UE's MME, the group context update procedure may include selection of a new MME and relocation thereof, wherein the UE's new MME may perform a group context retrieval procedure to retrieve required information for the respective UE/UEs from the UE's old MME (as illustrated in FIG. 11).

FIG. 10 shows a schematic diagram of a first example of the procedure of group-based updating of contexts according to exemplary embodiments of the present invention, in which the UE's MME/S-GW is not (needed to be) relocated.

In the exemplary case according to FIG. 10, it is assumed that the uplink and downlink traffic for the MR's first PDN connection has previously been routed via the source DeNB, and that, during a MR handover, the S1-MME/S1-U traffic path and respective contexts are updated in various nodes, as outlined below.

In step 1, the MR sends a Group Context Update Request message to the target DeNB. The message may include, but is not limited to, one or more of the following information for every affected UE (as indicated in a list of UEs or the like):
GUMMEI of UE's serving MME,
for S1-MME: a {eNB UE S1AP ID, MME UE S1AP ID} pair for the MR-DeNB S1-MME interface, and DeNB-UE's MME S1-MME interface,
for S1-U: for each E-RAB:
   +E-RAB ID, and
   +{GTP-U UL F-TEID, GTP-U DL F-TEID} pair for the MR-DeNB S1-U interface, and DeNB-UE's S-GW S1-U interface.

In step 2, the target DeNB sends the Group Context Update Request message to the UE's MME. The message may include, but is not limited to, one or more of the following information for every affected UE (as indicated in a list of UEs or the like):
GUMMEI of UE's serving MME,
for S1-MME: the {eNB UE S1AP ID, MME UE S1AP ID} pair for the DeNB-UE's MME S1-MME interface.
for S1-U: for each E-RAB:
   +E-RAB ID, and
   +{GTP-U UL F-TEID, GTP-U DL F-TEID} pair for the DeNB-UE's S-GW S1-U interface.

In step 3, if the UE's GTP-U DL F-TEID is changed, the UE's MME sends a Modify Bearer Request message to the UE's S-GW.

In step 4, the UE's S-GW updates the GTP-U DL F-TEID, and sends a Modify Bearer Response message to the UE's MME. The UE's S-GW may include GTP-U UL F-TEID in the Modify Bearer Response message, if the S-GW changes it.

The steps 3 and 4 may be repeated for every affected UE being connected to the MR and/or having to be updated in terms of additional context information, possibly by way of a new procedure to modify the bearer for a list of UEs.

In step 5, the UE's MME sends a Group Context Update Response message including at least the updated MME UE S1AP ID and/or GTP-U UL F-TEID, and/or any other context information related to the affected UEs, if there has occurred a change to them.

In step 6, the target DeNB updates the context information for the respective UE in the list of affected UEs. If there is any change to the MME UE S1AP ID for the MR-DeNB interface and/or the GTP-U UL F-TEID in the DeNB, and/or any other context information related to the affected UEs, the DeNB includes it/them in a Group Context Update Response message being sent to the MR.

Up to this point, the context information for S1-MME/S1-U is updated in all related nodes. The uplink and downlink for the UE's control plane can now be sent via MR-DeNBUE's MME. The uplink and downlink traffic for the UE's data plane can now be sent via MR-DeNB's eNB function-S-GW/P-GW collocated in the target DeNB-UE's S-GW.

FIG. 11 shows a schematic diagram of a second example of the procedure of group-based updating of contexts according to exemplary embodiments of the present invention, in which the UE's MME/S-GW is (needed to be) relocated.

In the exemplary case according to FIG. 11, it is assumed that the uplink and downlink traffic for the MR's first PDN connection has previously been routed via the source DeNB, and that the target DeNB cannot connect to the UE's MME. Accordingly, the target DeNB may select any arbitrary MME, which the selection method may be similar to a MME selection for an attach or TAU procedure, and then the new MME may initiate a S-GW relocation in the context of the S1-MME/S1-U traffic path and contexts update in various nodes during a MR handover, as outlined below.

In step 1, the MR sends a Group Context Update Request message to the target DeNB. The message may include, but is not limited to, one or more of the following information for every affected UE (as indicated in a list of UEs or the like):
GUMMEI of UE's serving MME,
for S1-MME: the {eNB UE S1AP ID, MME UE S1AP ID} pair for the MR-DeNB S1-MME interface, and DeNB-UE's MME S1-MME interface,
for S1-U: for each E-RAB:
   +E-RAB ID, and
   +{GTP-U UL F-TEID, GTP-U DL F-TEID} pair for the MR-DeNB S1-U interface, and DeNB-UE's S-GW S1-U interface.

In step 2, the target DeNB cannot connect to the UE's old MME. Therefore, the target DeNB selects an MME based on TAI and eNB ID of the target DeNB. Then, the target DeNB sends a Group Context Update Request message to the UE's new MME. The message may include, but is not limited to, one or more of the following information for every affected UE (as indicated in a list of UEs or the like):
GUMMEI of UE's serving MME,
for S1-MME: the {eNB UE S1AP ID, MME UE S1AP ID} pair for the DeNB-UE's MME S1-MME interface,
for S1-U: for each E-RAB:
   +E-RAB ID, and
   +{GTP-U UL F-TEID, GTP-U DL F-TEID} pair for the DeNB-UE's S-GW S1-U interface.

In step 3, the UE's new MME sends a Group Context Retrieval message to the UE's old new MME to retrieve the MM and EPS bearer context for the related UEs. The MME identifies the affected UE based on the received above-mentioned information. The Group Context Retrieval message may include, but is not limited to, one or more of the following information for every affected UE (as indicated in a list of UEs or the like), which can identify the UEs in the UE's old MME:
GUMMEI of UE's serving MME,
for S1-MME: the {eNB UE S1AP ID, MME UE S1AP ID} pair for the DeNB-UE's MME S1-MME interface,
for S1-U: for each E-RAB:
   +E-RAB ID, and
   +{GTP-U UL F-TEID, GTP-U DL F-TEID} pair for the DeNB-UE's S-GW S1-U interface.

The group context retrieval procedure may alternatively be implemented via the enhancement to a currently specified context request procedure by adding the above-mentioned information elements.

In step 4, the UE's old MME replies with a Group Context Retrieval Response message contain the MM and EPS bearer context for the affected UEs.

In case that the UEs are served by different MMES, steps 3 and Step 4 are repeated for/by every affected UE's MME.

In step 5, the UE's new MME sends a Create Session Request message (for initiating bearer modification) to the UE's new S-GW.

In step 6, the UE's new S-GW sends a Modify Bearer Request message to the UE's P-GW.

In step 7, the UE's P-GW updates the GTP-U DL F-TEID, and sends a Modify Bearer Response message to the UE's new S-GW. The UE's P-GW may include GTP-U UL F-TEID in the Modify Bearer Response message, if the P-GW changes it.

In step 8, the UE's new S-GW sends a Create Session Response message to the UE's new MME. The UE's new S-GW may include GTP-U UL F-TEID in the Create Session Response message, if it has been changed.

The steps 5 to 8 or 6 to 7 may be repeated for every affected UE being connected to the MR and/or having to be updated in terms of additional context information, possibly by way of a new procedure to modify the bearer for a list of UEs.

In step 9, the UE's new MME sends a Group Context Update Response message including at least the updated MME UE S1AP ID and/or GTP-U UL F-TEID, and/or any other context information related to the affected UEs, if there has occurred a change to them.

In step 10, the target DeNB updates the context information for the respective UE in the list of affected UEs. If there is any change to the MME UE S1AP ID for the MR-DeNB interface and/or the GTP-U UL F-TEID in the DeNB, and/or any other context information related to the affected UEs, the DeNB includes it/them in a Group Context Update Response message being sent to MR.

Up to this point, the context information for S1-MME/S1-U is updated in all related nodes. The uplink and downlink for the UE's control plane can now be sent via MR-DeNB-UE's MME. The uplink and downlink traffic for the UE's data plane can now be sent via MR-DeNB's eNB function-S-GW/P-GW collocated in the target DeNB-UE's new S-GW.

In view of the above, exemplary embodiments of the present invention may comprise, at/by a MR, initiating a group context update procedure for the one or more contexts of user terminals connecting to the mobile relay towards a target base station of the mobile relay after a handover thereof on the basis of the received additional context information, and/or using updated context information for transmission and/or tunneling of the traffic for the first-type user terminals, wherein the group context update procedure for the one or more contexts of user terminals may comprise triggering a group context update procedure for updating the one or more contexts of user terminals in at least one of the mobile relay, the target base station, a mobility management entity of the user terminals, any mobility management entity in case the mobility management entity of the user terminal is unavailable, and a serving gateway entity of the user terminals.

Further, exemplary embodiments of the present invention may comprise, at/by a DeNB, receiving an initiation of a group context update procedure for the one or more contexts of user terminals connecting to the mobile relay from the mobile relay, and/or initiating a group context update procedure for the one or more contexts of user terminals connecting to the mobile relay towards a mobility management entity of the user terminal, and/or using updated context information for transmission and/or tunneling of the traffic for the first-type user terminals. Still further, the context update procedure for the context of one or more user terminals may comprise one or more of selecting a mobility management entity of the user terminal in case the mobility management entity of the user terminal is unavailable, triggering a group context update procedure for updating the context of one or more user terminals in at least one of the a target base station of the mobile relay after a handover thereof, a mobility management entity of the user terminals, and a serving gateway entity of the user terminals, and/or initiating a group context retrieval from the mobility management entity of the user terminal in case a relocation of the mobility management entity is performed.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

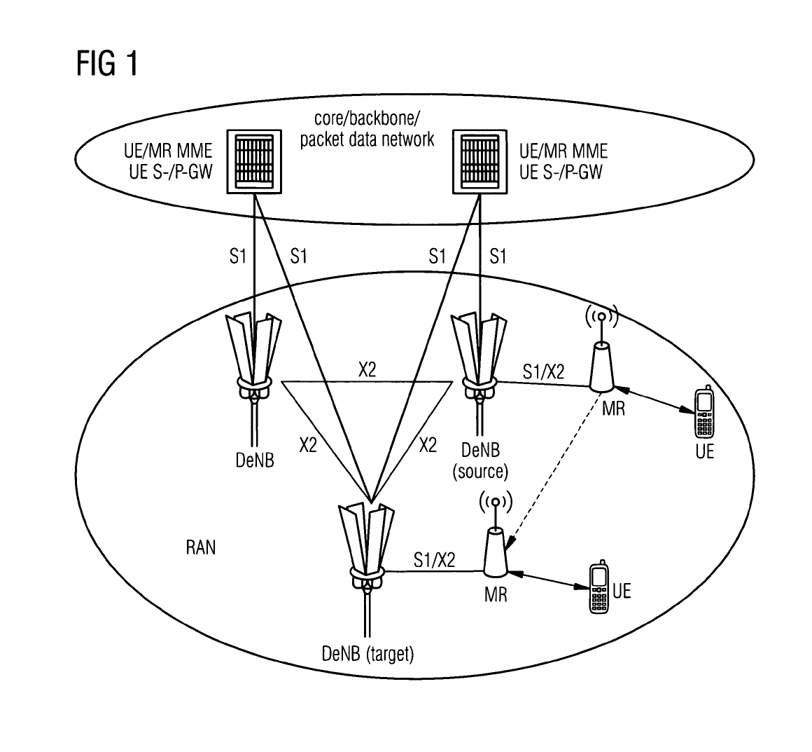

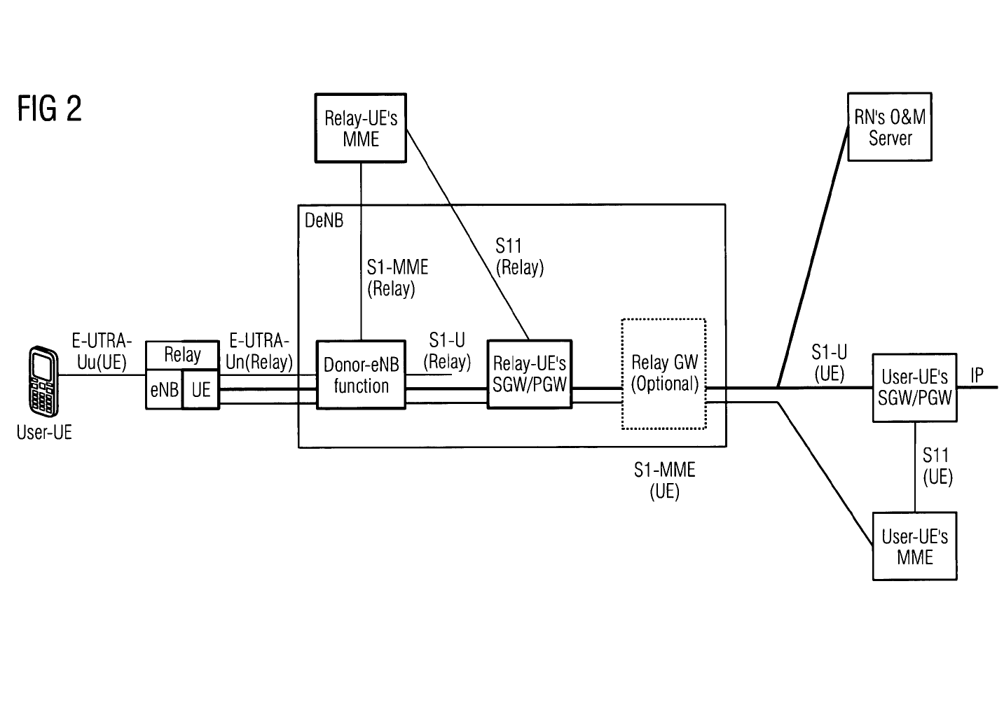

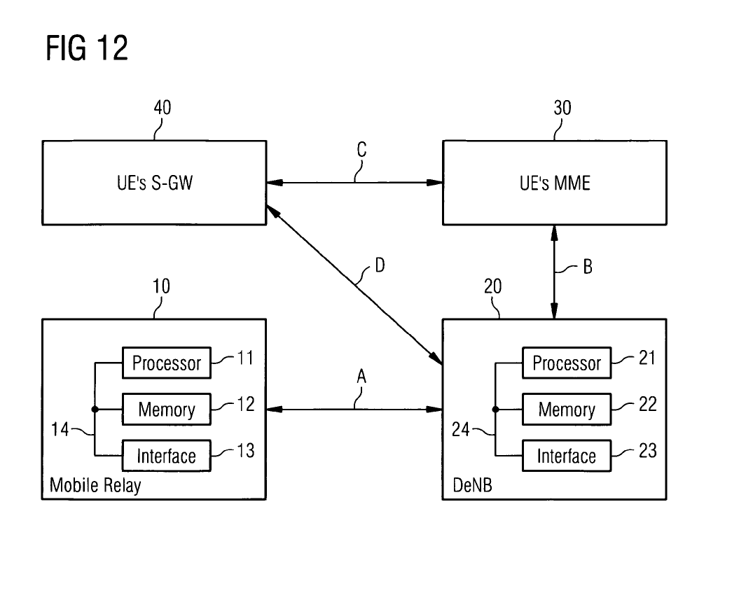

Respective exemplary embodiments of the present invention are described below referring to FIG. 12, while for the sake of brevity reference is made to the detailed description of respective corresponding methods and operations according to FIGS. 5 to 11 as well as the underlying system architectures according to FIG. 1.

In FIG. 12 below, the solid line blocks are basically configured to perform respective operations as described above. The entirety of solid line blocks are basically configured to perform the methods and operations as described above, respectively. With respect to FIG. 12, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 12, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 12 shows a schematic diagram of apparatuses according to exemplary embodiments of the present invention. As mentioned above, it is noted that the illustration of (electronic) devices according to FIG. 12 is simplified.

In view of the above, the thus described apparatuses 10 to 40 are suitable for use in practicing the exemplary embodiments of the present invention, as described herein.

The thus described apparatus 10 may represent a (part of a) mobile relay MR, as described above, and may be configured to perform a procedure and/or exhibit a functionality as described in conjunction with any one of FIGS. 5 to 11. The thus described apparatus 20 may represent a (part of a) base station or access node such as a DeNB, as described above, and may be configured to perform a procedure and/or exhibit a functionality as described in conjunction with any one of FIGS. 5 to 11. The thus described apparatus 30 may represent a (part of a) mobile management entity such as a UE's (new) MME, as described above, and may be configured to perform a procedure and/or exhibit a functionality as described in conjunction with any one of FIGS. 5, 6 to 8, 10 and 11. The thus described apparatus 40 may represent a (part of a) serving gateway functionality such as a UE's (new) S-GW, as described above, and may be configured to perform a procedure and/or exhibit a functionality as described in conjunction with any one of FIGS. 5, 6 to 8, 10 and 11.

It is noted that, while not being illustrated in FIG. 12, the apparatus 20 may comprise or implement the MR's P-GW functionality for accomplishing a connection from the DeNB to the UE's MME and/or the UE's S-GW. Further, the apparatus 20 may additionally be connected to one or more apparatuses representing the MR's O&M server, UMTS-RNC or HNB-GW, GSM-BSC, WiFi-Core, and the like, wherein such connection would be accomplished via an electronic apparatus or device representing the MR's P-GW functionality. This is evident from FIGS. 6 to 8.

In view thereof, exemplary embodiments of the present invention provide for the MR's P-GW functionality being incorporated in the DeNB and/or being implemented as/in a standalone apparatus.

As indicated in FIG. 12, according to embodiments of the present invention, each of the apparatuses comprises a processor 11/22/ . . . , a memory 12/22/ . . . and an interface 13/23/ . . . , which are connected by a bus 14/24/ . . . or the like, and the apparatuses may be connected via respective links A, B, C, and D.

The processor 11/21/ . . . and/or the interface 13/23/ . . . may also include a modem or the like to facilitate communication over a (hardwired or wireless) link, respectively. The interface 13/23/ . . . may include a suitable transceiver coupled to one or more antennas or communication means for (hardwire or wireless) communications with the linked or connected device(s), respectively. The interface 13/23/ . . . is generally configured to communicate with at least one other apparatus, i.e. the interface thereof.

The memories 12/22/ . . . may store respective programs assumed to include program instructions or computer program code that, when executed by the respective processor, enables the respective electronic device or apparatus to operate in accordance with the exemplary embodiments of the present invention. Further, the memories 12/22/ . . . may store one or more of the aforementioned parameters, traffic, data and information, respectively.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, the apparatus 10 or its processor 11 is configured to perform setting up a first packet data connection for traffic in a relay-enhanced access network, which relates to first-type user terminals using the same access technology as a base station from a mobile relay towards a packet data network via a first packet gateway functionality collocated with the base station currently serving the mobile relay, and setting up a second packet data connection for traffic in the relay-enhanced access network, which relates to at least one of second-type user terminals using another access technology as the base station and the mobile relay (such as the mobile relay's operation and maintenance traffic), from the mobile relay towards the packet data network via a second packet gateway functionality external to the base station currently serving the mobile relay.

According to exemplary embodiments of the present invention, the apparatus 10 or its processor 11 may be configured to perform one or more of:
receiving additional context information for one or more contexts of user terminals connecting to the mobile relay from a source base station, possibly prior to a handover of the mobile relay,
receiving additional context information for a context of a user terminal in a handover request message upon initiation of a S1 handover of the user terminal towards the mobile relay, a path switch request acknowledgement message upon initiation of a X2 handover of the user terminal towards the mobile relay, or an initial context setup request message upon attachment of the user terminal to the mobile relay,
initiating a group context update procedure for the one or more contexts of user terminals connecting to the mobile relay towards a target base station of the mobile relay after a handover thereof on the basis of the received additional context information, possibly during a handover of the mobile relay,
using updated context information for transmission and/or tunneling of the traffic for the first-type user terminals,
in the group context update procedure for one or more contexts of a user terminal, triggering a group context update procedure for updating the one or more contexts of the user terminals in at least one of the mobile relay, the target base station, a mobility management entity of the user terminal, any mobility management entity in case the mobility management entity of the user terminal is unavailable, and a serving gateway entity of the user terminal, and
receiving a context update response message from the target base station, which includes any updated information enabling transmission and/or tunneling of control plane and user plane traffic for the user terminal between the mobile relay and a mobility management entity and/or a serving gateway functionality of the user terminal.

According to exemplary embodiments of the present invention, the apparatus 20 or its processor 21 is configured to perform servicing a first packet data connection for traffic in a relay-enhanced access network, which relates to the first-type user terminals using the same access technology as a base station, from a mobile relay towards a packet data network via a first packet gateway functionality collocated with the base station currently serving the mobile relay, and servicing a second packet data connection for traffic in the relay-enhanced access network, which relates to at least one of second-type user terminals using another access technology as the base station and the mobile relay (such as the mobile relay's operation and maintenance traffic), from the mobile relay towards the packet data network via a second packet gateway functionality external to the base station currently serving the mobile relay.

The DeNB terminates the interface for interacting with the external P-GW.

According to exemplary embodiments of the present invention, the apparatus 20 or its processor 21 may be configured to perform one or more of:
transmitting additional context information for one or more contexts of user terminals connecting to the mobile relay, possibly prior to a handover of the mobile relay,
transmitting the additional context information for a context of a user terminal in a handover request message upon initiation of a S1 handover of the user terminal towards the mobile relay, a path switch request acknowledgement message upon initiation of a X2 handover of the user terminal towards the mobile relay, or an initial context setup request message upon attachment of the user terminal to the mobile relay,
receiving an initiation of a context update procedure for the one or more contexts of user terminals connecting to the mobile relay from the mobile relay,
selecting a new mobility management entity in case the mobility management entity of the user terminal is unavailable,
initiating a group context update procedure for the one or more contexts of user terminals connecting to the mobile relay towards a mobility management entity of the user terminal, and/or using updated context information for transmission and/or tunneling of the traffic for the first-type user terminals
in the group context update procedure for the context of a user terminal, any one of selecting a mobility management entity of the user terminal in case the mobility management entity of the user terminal is unavailable, triggering a group context update procedure for updating the one or more contexts of user terminals in at least one of the a target base station of the mobile relay after a handover thereof, a mobility management entity of the user terminal, and a serving gateway entity of the user terminal, and initiating a group context retrieval from the mobility management entity of the user terminal in case a relocation of the mobility management entity is performed,
in the context update procedure for the context of a user terminal, receiving a context update response message from the mobility management entity of the user terminal, which includes any updated information enabling transmission and/or tunneling of the traffic for the user terminal between the base station and a mobility management entity and/or a serving gateway functionality of the user terminal, and/or
in the context update procedure for the context of a user terminal, transmitting a context update response message to the mobile relay, which includes any updated information enabling transmission and/or tunneling of control plane and user plane traffic for the user terminal between the mobile relay and a mobility management entity and/or a serving gateway entity of the user terminal.

According to exemplarily embodiments of the present invention, the processor 11/21/ . . . , the memory 12/22/ . . . and the interface 13/23/ . . . may be implemented as individual modules, chipsets or the like, or one or more of them can be implemented as a common module, chipset or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts.

The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for mobile relay support in relay-enhanced access networks. Such measures may exemplarily comprise setting up a first packet data connection for traffic in a relay-enhanced access network, which relates to first-type user terminals using the same access technology as a base station, from a mobile relay towards a packet data network via a first packet gateway functionality collocated with the base station currently serving the mobile relay, and setting up a second packet data connection for traffic in the relay-enhanced access network, which relates to second-type user terminals using another access technologies as the base station and the mobile relay (such as the mobile relay's operation and maintenance traffic), from the mobile relay towards the packet data network via a second packet gateway functionality external to the base station currently serving the mobile relay. Such measures may exemplarily also comprise at least one of conveying additional context information for one or more contexts of user terminals connecting to the mobile relay from a source base station to the mobile relay, and initiating a group context update procedure for one or more contexts of user terminals connecting to the mobile relay in at least one of the mobile relay, the target base station, a mobility management entity of the user terminal, any selected mobility management entity in case the mobility management entity of the user terminal is unavailable, and a serving gateway entity of the user terminal.

The measures proposed according to exemplary embodiments of the present invention may be applied for any kind of network environment, particularly in any kind of relay-enhanced network environment, such as for example for those in accordance with 3GPP RAN2/RAN3 standards and/or 3GPP LTE standards of release 10/11/12/ . . . (LTE-Advanced and its evolutions).

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

### 3GPP 3rd Generation Partnership Project

### AP Access Point

### BSC Base Station Controller

### BTS Base Transceiver Station

### CN Core Network

### DeNB Donor eNB

### DL Downlink

eNB evolved NodeB

### EPC Evolved Packet Core

### EPS Evolved Packet Service

### E-RAB E-UTRAN Radio Access Bearer

### E-UTRAN Enhanced UTRAN

### F-TEID Full Qualified TEID

### GPRS General Packet Radio Service/System

### GSM Global System for Mobile Communication

### GTP GPRS Tunneling Protocol

### GW Gateway

### GUMMEI Globally Unique MME Identifier

### HNB Home Node B

### HNB-GW HNB Gateway

### IEEE Institute of Electrical and Electronics Engineers

### ID Identifier

### IP Internet Protocol

### LTE Long Term Evolution

### MM Mobility Management

### MME Mobility Management Entity

### MR Mobile Relay

### O&M Operation and Maintenance

### P-GW PDN Gateway

### PDN Packet Data Network

### RAN Radio Access Network

### RN Relay Node

### RNC Radio Network Controller

### S1AP S1 Application Protocol

### S-GW Serving Gateway

### TAI Tracking Area Identifier

### TAU Tracking Area Update

### TEID Tunnel Endpoint Identifier

### UE User Equipment

### UL Uplink

Un Interface between RN/MR and DeNB

### UTRAN Universal Terrestrial Radio Access Network

Uu Interface between UE and RN/MR or UE and DeNB
Um Interface between GSM UE and BTS

### WAG WiFi Access Gateway

WiFi Wireless Fidelity

1. A method comprising
setting up a first packet data connection for traffic in a relay-enhanced access network, which relates to first-type user terminals using the same access technology as a base station from a mobile relay towards a packet data network via a first packet gateway functionality collocated with the base station currently serving the mobile relay, and
setting up a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

2. The method according to claim 1, wherein
during a handover of the mobile relay, the first packet gateway functionality is relocated from a source base station to a target base station of the mobile relay, and the second packet gateway functionality is maintained, and/or
the base station terminates an interface for interacting with the external packet gateway functionality.

3. The method according to claim 1, further comprising
receiving additional context information for one or more contexts of user terminals connecting to the mobile relay from a source base station.

4. The method according to claim 3, wherein
the additional context information for a context of a user terminal comprises at least one of an identifier of a mobility management entity of the user terminal, an application identifier assigned by the mobility management entity of the user terminal, an uplink tunneling protocol endpoint of the user terminal, and another information enabling transmission and/or tunneling the traffic for the user terminal between the mobile relay and a mobility management entity and/or a serving gateway entity of the user terminal.

5. The method according to claim 3, wherein
the additional context information for one or more contexts of first-type user terminals is received prior to the handover of the mobile relay, and/or
the additional context information for a context of a user terminal is received in a handover request message upon initiation of a S1 handover of the user terminal towards the mobile relay, a path switch request acknowledgement message upon initiation of a X2 handover of the user terminal towards the mobile relay, or an initial context setup request message upon attachment of the user terminal to the mobile relay.

6. The method according to claim 3, further comprising
initiating a group context update procedure for the one or more contexts of user terminals connecting to the mobile relay towards a target base station of the mobile relay after a handover thereof on the basis of the received additional context information, and
using updated context information for transmission and/or tunneling of the traffic for the first-type user terminals.

7. The method according to claim 6, wherein
the group context update procedure for the one or more contexts of user terminals comprises triggering a group context update procedure for updating the one or more contexts of user terminals in at least one of the mobile relay, the target base station, a mobility management entity of the user terminals, any mobility management entity in case the mobility management entity of the user terminal is unavailable, and a serving gateway entity of the user terminals.

8-9. (canceled)

10. The method according to claim 1, wherein
the method is operable at or by the mobile relay, and/or
the mobile relay is operable with multiple access technologies on an access link between the mobile relay and user terminals connecting to the mobile relay, and/or
the base station currently serving the mobile relay comprises a source base station prior to a handover of the mobile relay or a target base station during and after a handover of the mobile relay, and/or
the mobile relay and the source and/or target base station are operable in accordance with an LTE or LTE-Advanced radio access system.

11. A method comprising
servicing a first packet data connection for traffic in a relay-enhanced access network, which relates to the first-type user terminals using the same access technology as a base station, from a mobile relay towards a packet data network via a first packet gateway functionality collocated with the base station currently serving the mobile relay, and
servicing a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

12. The method according to claim 11, wherein
during a handover of the mobile relay, the first packet gateway functionality is relocated from a source base station to a target base station of the mobile relay, and the second packet gateway functionality is maintained, and/or
the base station terminates an interface for interacting with the external packet gateway functionality.

13. The method according to claim 11, further comprising
transmitting additional context information for one or more contexts of user terminals connecting to the mobile relay to the mobile relay.

14. The method according to claim 13, wherein
the additional context information for a context of a user terminal comprises at least one of an identifier of a mobility management entity of the user terminal, an application identifier assigned by the mobility management entity of the user terminal, an uplink tunneling protocol endpoint of the user terminal, and another information enabling transmission and/or tunneling the traffic for the user terminal between the mobile relay and a mobility management entity and/or a serving gateway entity of the user terminal.

15. The method according to claim 13, wherein
the additional context information for one or more contexts of a first-type user terminals is transmitted prior to a handover of the mobile relay, and/or
the additional context information for a context of a user terminal is transmitted in a handover request message upon initiation of a S1 handover of the user terminal towards the mobile relay, a path switch request acknowledgement message upon initiation of a X2 handover of the user terminal towards the mobile relay, or an initial context setup request message upon attachment of the user terminal to the mobile relay.

16. The method according to claim 13, further comprising
receiving an initiation of a group context update procedure for the one or more contexts of user terminals connecting to the mobile relay from the mobile relay,
initiating a group context update procedure for the one or more contexts of user terminals connecting to the mobile relay towards a mobility management entity of the user terminal, and
using updated context information for transmission and/or tunneling of the traffic for the first-type user terminals.

17. The method according to claim 16, wherein
the mobility management entity comprises the mobility management entity of a user terminal or, in case the mobility management entity of a user terminal is unavailable, a selected mobility management entity, and/or
the context update procedure for the context of one or more user terminals comprises selecting a mobility management entity of the user terminal in case the mobility management entity of the user terminal is unavailable, triggering a group context update procedure for updating the context of one or more user terminals in at least one of the a target base station of the mobile relay after a handover thereof, a mobility management entity of the user terminals, and a serving gateway entity of the user terminals, and/or initiating a group context retrieval from the mobility management entity of the user terminal in case a relocation of the mobility management entity is performed.

18-19. (canceled)

20. The method according to claim 11, wherein
the method is operable at or by the base station currently serving the mobile relay, which comprises a source base station prior to a handover of the mobile relay or a target base station during and after a handover of the mobile relay, and/or
the mobile relay is operable with multiple access technologies on an access link between the mobile relay and user terminals connecting to the mobile relay, and/or
the mobile relay and the source and/or target base station are operable in accordance with an LTE or LTE-Advanced radio access system.

21. An apparatus comprising
at least one processor; and
at least one memory including computer program code,
the at least one memory and the computer program code configured, with the at least one processor, to cause the apparatus to perform at least the following:
setting up a first packet data connection for traffic in a relay-enhanced access network, which relates to the first-type user terminals using the same access technology as a base station, from a mobile relay towards a packet data network via a first packet gateway functionality collocated with a base station currently serving the mobile relay, and
setting up a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

22-30. (canceled)

31. An apparatus comprising
at least one processor configured to cause the apparatus to perform; and
at least one memory including computer program code,
the at least one memory and the computer program code configured, with the at least one processor, to cause the apparatus to perform at least the following:
servicing a first packet data connection for traffic in a relay-enhanced access network, which relates to the first-type user terminals using the same access technology as a base station, from a mobile relay towards a packet data network via a first packet gateway functionality collocated with a base station currently serving the mobile relay, and
servicing a second packet data connection for traffic in the relay-enhanced access network, which relates to at least one of second-type user terminals using another access technology as the base station and the mobile relay, from the mobile relay towards the packet data network via a second packet gateway functionality external to the base station currently serving the mobile relay.

32-40. (canceled)

41. A computer program product comprising computer-executable computer program code which, when the program is run on a computer, is configured to cause the computer to carry out the method according to claim 1.

42. The computer program product according to claim 41, wherein the computer program product comprises a computer-readable medium on which the computer-executable computer program code is stored, and/or wherein the program is directly loadable into an internal memory of the processor.
